(19) United States
(12) Patent Application Publication
(10) Pub. No.: US 2014/0070089 A1
(43) Pub. Date: Mar. 13, 2014

(54) IONIZATION DEVICE, MASS SPECTROMETER INCLUDING THE IONIZATION DEVICE, AND IMAGE GENERATION SYSTEM INCLUDING THE IONIZATION DEVICE

(71) Applicant: CANON KABUSHIKI KAISHA, Tokyo (JP)

(72) Inventor: Yoichi Otsuka, Kawasaki-shi (JP)

(21) Appl. No.: 14/017,560

(22) Filed: Sep. 4, 2013

(30) Foreign Application Priority Data
Sep. 7, 2012 (JP) 2012-197206

(51) Int. Cl. H01J 49/16; H01J 49/26

(52) U.S. Cl. CPC H01J 49/16; H01J 49/26
USPC 250/282; 250/423 R; 250/288

(57) ABSTRACT

An ionization device includes a laser light irradiation unit, a liquid holding unit having an end portion thereof and being configured to hold a liquid on an outer periphery of the end portion, an extract electrode, and a voltage application unit. The device is configured to operate in at least in two operation modes, and the modes include a first operation mode, in which the liquid at the end portion is brought into contact with the surface of the sample and then ionized particles are generated from the end portion, and a second operation mode, in which the liquid at the end portion is disposed at a location separated from the surface of the sample and the particles desorbed from the surface of the sample as a result of being irradiated with the laser light are ionized using the liquid on the end portion.

### BACKGROUND OF THE INVENTION

1. Field of the Invention

The present invention relates to devices and methods for ionizing solid samples. Ionization devices and methods disclosed herein may be applicable to mass spectrometry imaging.

2. Description of the Related Art

There exists a technique for ionizing a solid sample under an atmospheric pressure environment in order to analyze components in the surface of that solid sample.

In addition, research is being performed in the field of imaging mass spectrometry (IMS). In IMS, with the use of an ionization technique, the types of substances present on the surface of a sample and locations of such substances on the surface of the sample can be advantageously displayed as an image for a user.

Japanese Patent Laid-Open No. 2008-147165 discusses a method for ionizing a sample obtained from a fine region of a solid sample, in which laser light irradiation and electrospray ionization are combined to obtain mass spectra information of substance contained in the solid sample. In such a method, a solid material on a substrate is first irradiated with laser light in an atmospheric pressure environment, and components in a fine region of the solid material are desorbed in the form of fine particles. Then, charged liquid droplets generated by an electrospray, which is arranged in the horizontal direction, are sprayed on the fine particles to ionize the components in the fine particles. Thereafter, generated ions are introduced into a mass spectrometer to measure the mass-to-charge ratios of the ions, and thus the components are analyzed. This method makes it possible to obtain the component distribution of a solid sample with ease.

U.S. Pat. No. 8,097,845 discusses a method in which a solvent is applied to a fine region of a solid surface in an atmospheric pressure environment and substances (solutes) that have dissolved in the solvent are ionized.

The method discussed in U.S. Pat. No. 8,097,845 uses two capillaries. The two capillaries are disposed such that an end portion of each capillary is in close proximity to the solid surface. One of the capillaries serves to supply the solvent to the solid surface, and the other capillary serves to suction (collect), at one end thereof, the solvent in which components contained in the solid have dissolved (i.e., solution) and transport the solution to an ionization section provided at the other end thereof. The solution that has been suctioned at one end of the other capillary is transported to the other end thereof, and then a high voltage is applied to the solution. Thus, the solutes are ionized in the ionization section provided at the other end of the other capillary.

With the method discussed in Japanese Patent Laid-Open No. 2008-147165, when the solid sample is irradiated with the laser light, fine particles containing a plurality of components are generated simultaneously and then ionized. Accordingly, mass spectra that are ultimately obtained include signals resulting from the components contained in the multiple substances, and thus the test result is difficult to interpret in some cases.

With the method discussed in U.S. Pat. No. 8,097,845, what components move to the ionization section depends on the solubility of the solvent used, and thus selecting a certain solvent enables sampling of specific components, which makes it easier to interpret obtained mass spectra. Meanwhile, only components that dissolve in a solvent can be ionized, and thus mass spectra of insoluble substances may not be obtained.

Furthermore, since a process of causing components in a sample to dissolve in a solvent (i.e., sampling process) and a process of causing ionization (i.e., ionization process) are carried out in distinct locations, the solution after the sampling needs to be transported through the capillary tube. That is, a mechanism for transporting a liquid is required, and a time difference is generated between the sampling and the ionization due to the transportation. Thus, it is difficult to carry out high-speed analysis. In addition, components dissolving in a solution may adhere to the inside of a flow channel in the capillary and may accumulate therein. If this is used to analyze the sample surface, the accumulated components affect the result of the analysis, and thus reliability decreases in some cases.

### SUMMARY OF THE INVENTION

An exemplary embodiment of the present invention is directed to a technique to be employed when components in a fine region of a solid sample are made to dissolve and are ionized in an atmospheric pressure environment. This novel technique makes it possible to temporally separate a component that easily dissolves in a solvent from a component that does not easily dissolve in the solvent and to carry out sampling and ionization of the sample at high speed.

According to an aspect of the present invention, an ionization device includes a laser light irradiation unit configured to irradiate at least a region of a surface of a sample with laser light to desorb particles from the sample, a liquid holding unit having an end portion and configured to hold a liquid on an outer periphery of the end portion, an extract electrode configured to extract ionized ions, and a voltage application unit configured to apply a voltage between the liquid and the extract electrode to cause the ions to generate from the liquid held on the outer periphery of the end portion. The ionization device is configured to operate at least in two operation modes, and the two operation modes include a first operation mode, in which the liquid at the end portion is brought into contact with the surface of the sample and then ionized particles are generated from the end portion, and a second operation mode, in which the liquid at the end portion is disposed at a location separated from the surface of the sample and the particles desorbed from the surface of the sample as a result of being irradiated with the laser light are ionized using the liquid on the end portion.

According to an exemplary embodiment of the present invention, an ion analysis device that excels in ionization in an atmospheric pressure environment can be provided. Furthermore, a component that easily dissolves in a solvent and a component that does not easily dissolve in the solvent can be ionized at distinct timings, which allows obtained mass spectra to be interpreted with ease.

In addition, ionizing a component that does not easily dissolve in a solvent after ionizing a component that easily dissolves in the solvent makes it possible to separate the components to be analyzed and to ionize the components at distinct times. Thus, obtained mass spectra can be interpreted more easily.

Further features of the present invention will become apparent from the following description of exemplary embodiments with reference to the attached drawings.

### BRIEF DESCRIPTION OF THE DRAWINGS

FIGS. 1A and 1B are schematic diagrams each illustrating an image generation system that includes an ionization device according to a first exemplary embodiment.

FIG. 2 is a schematic diagram illustrating operation timings of constituent elements in the ionization device according to the first exemplary embodiment.

FIGS. 3A and 3B are schematic diagrams each illustrating an image generation system that includes an ionization device according to a second exemplary embodiment.

FIG. 4 is a schematic diagram illustrating operation timings of constituent elements in the ionization device according to the second exemplary embodiment.

FIG. 5 is a schematic diagram illustrating an image generation system that includes an ionization device according to a third exemplary embodiment.

FIG. 6 is a schematic diagram illustrating a synchronization circuit of an ionization device according to an exemplary embodiment of the present invention.

### DESCRIPTION OF THE EMBODIMENTS

### First Exemplary Embodiment

An ionization device according to a first exemplary embodiment of the present invention includes a liquid supply unit configured to supply a solvent to a sample, a liquid holding unit configured to form a liquid bridge between the sample and the liquid holding unit, and a laser light irradiation unit configured to irradiate the sample with laser light. The laser light irradiation unit is disposed so as to be capable of irradiating a desired location on the surface of the sample with the laser light emitted from a laser light source.

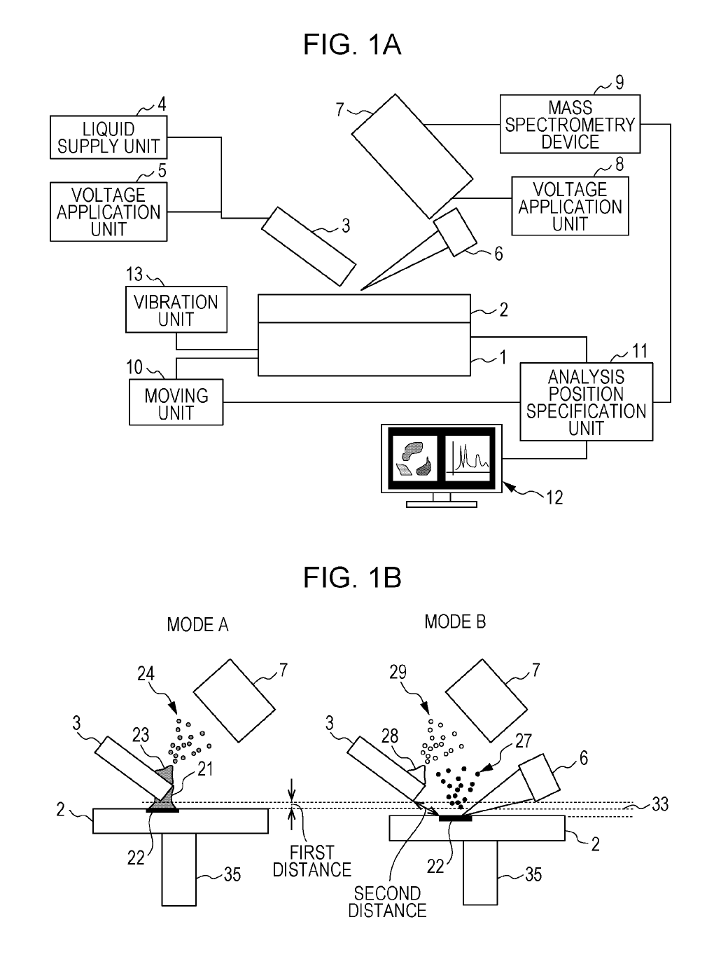

FIGS. 1A and 1B are schematic diagrams each illustrating an image generation system that includes the ionization device according to the first exemplary embodiment of the present invention. FIG. 1A illustrates the entire image generation system, and FIG. 1B illustrates a device system around an end portion of the liquid holding unit, which constitutes part of the image generation system.

A sample 2 is placed on and is supported by a support 1. The sample 2 is a section (cell group) of biological tissue. A liquid holding unit 3 is a needle-shaped instrument, which is disposed such that one end thereof (end portion) is in contact with or, as illustrated in FIGS. 1A and 1B, is in close proximity to the sample 2. A flow channel (not illustrated) is formed inside the liquid holding unit 3, and a solvent is supplied to the surface of the sample 2 through the flow channel. The solvent is a liquid in which a substance contained in the sample 2 can dissolve as a solute. In the first exemplary embodiment, the liquid is a mixture of water, an organic solvent, and an acid or a base. As this mixture serving as the solvent makes contact with the sample 2, a substance (e.g., at least one of a lipid, a saccharide, and a molecule having a mean molecular weight of 20 or more but less than a hundred million) contained in the sample 2 that easily dissolves in the solvent readily dissolves. Here, “dissolving in a solvent” refers to a state where molecules, atoms, and fine particles are dispersed in the solvent.

Examples of substances that easily dissolve include a lipid molecule forming a cell membrane, a saccharide contained in a cell, and a floating protein. Examples of substances that do not easily dissolve include a protein forming a cytoskeleton and a protein anchored to the cytoskeleton.

The solvent is supplied continuously from a liquid supply unit 4 to the liquid holding unit 3, and a voltage is applied to the solvent, while the liquid is being supplied, by a voltage application unit 5. The solvent that has been supplied to the liquid holding unit 3 then forms a liquid bridge 21 between an end portion of the liquid holding unit 3 and the sample 2. “Forming a liquid bridge” refers to a state in which the liquid physically connects a space between the end portion of the liquid holding unit 3 and the sample 2 (as illustrated in FIG. 1B: MODE A). Formation of the liquid bridge 21 allows a substance at the surface of the sample 2 to dissolve in the liquid. The liquid bridge 21 is formed in an atmospheric pressure environment. The liquid bridge 21 has a small volume of approximately 1×10⁻¹² m³. The area (cross-section) of the liquid bridge 21 along an in-plane direction of the sample 2 is approximately 1×10⁻⁸ m². That is, the liquid bridge 21 is located on a part of the surface of the sample 2.

An ion extract electrode 7 and a voltage application unit 8 for applying a voltage to the ion extract electrode 7 are provided in order to generate a Taylor cone 23 at the end portion of the liquid holding unit 3. A large potential difference (1 kV or more but 10 kV or less, or preferably 3 kV or more but 5 kV or less) between the liquid on the liquid holding unit 3 and the ion extract electrode 7 causes the liquid to form the Taylor cone 23. The Taylor cone 23 has a conical shape with the apex thereof oriented toward the ion extract electrode 7.

The charged liquid at the apex of the Taylor cone 23 is pulled off the Taylor cone 23 to form charged liquid droplets 24 (as shown in FIG. 1B: MODE A). The charged liquid droplets 24 are then sprayed toward the ion extract electrode 7.

A substance contained in the liquid droplets 24 is introduced into a mass spectrometer in an ionized state. The mass spectrometer measures the mass-to-charge ratio (m/z) of the substance. Note that a series of processes including the formation of the Taylor cone 23, spraying of the charged liquid droplets 24, and the ionization is referred to as electrospray ionization, hereinafter. As described above, the substance that is contained within the fine region 22 of the sample 2 and that easily dissolves in the solvent is ionized at the end portion of the liquid holding unit 3. The above processes will be referred to as a first operation mode (mode A).

After the ionization in the mode A, the distance between end portion of the liquid holding unit 3 and the sample 2 is increased by a position changing unit 35 to eliminate the liquid bridge 21.

That is, the position changing unit 35 is configured to change a relative distance between the liquid holding unit 3 and the sample 2 between a first distance, in which a liquid at least at the end portion of the liquid holding unit 3 makes contact with the fine region 22 of the sample 2 to form the liquid bridge 21, and a second distance, in which the liquid at the end portion of the liquid holding unit 3 is not in contact with the fine region 22 of the sample 2.

After the liquid at the end portion of the liquid holding unit 3 is brought into contact with the surface of the sample 2 by the position changing unit 35, the following two modes of ionization can be carried out. Namely, in the first operation mode (mode A), ionized particles are emitted from the end portion of the liquid holding unit 3, and in a second operation mode (mode B), the liquid at the end portion of the liquid holding unit 3 is moved to a position separated from the surface of the sample 2, and the particles that are desorbed from the surface of the sample 2 as a result of being irradiated with the laser light are ionized using the liquid at the end.

In the second operation mode, the liquid held on the outer periphery of the end portion of the liquid holding unit 3 may be located above the fine region 22 so as to take in the particles desorbed as a result of being irradiated with the laser light.

As illustrated in FIG. 1B: in MODE A, the end portion of the liquid holding unit 3 and sample surface 22 are separated by a First Distance; and in MODE B, the end portion of the liquid holding unit 3 are separated by a Second Distance. The first and second distances can be defined as the shortest distances, respectively, between the end portion of the liquid holding unit 3 and the surface of sample 2. The first and second distances are to be set appropriately in accordance with the amount of liquid held by the liquid holding unit 3. It is preferable to determine in advance the amount of liquid to be held by the liquid holding unit 3 and then obtain suitable first and second distances using a surface of a sample for testing.

A laser light irradiation unit 6 that emits laser light includes a light source that is arranged such that the laser light hits the fine region 22 of the sample 2 at which the liquid bridge 21 was formed. The laser light irradiation unit 6 is disposed at a side of the sample 2, that is, at a side of the support 1 where the sample 2 is to be placed.

The support 1 includes a vibration unit 13, and the vibration unit 13 causes the liquid bridge 21 to vibrate. The vibration unit 13 is configured to cyclically change the relative distance between the end portion of the liquid holding unit 3 and the sample 2, and increasing or decreasing the relative distance makes it possible to improve the ionization efficiency of the sample 2.

As a system for checking a focus position of the laser light, a camera for observing an irradiation spot may be included in the laser light irradiation unit 6. Then, by observing light from the focus position with the camera and by adjusting the position of the laser light irradiation unit 6 or the liquid holding unit 3 so that the position of the liquid bridge 21 coincides with the focus position of the laser light, the sample 2 can be irradiated with the laser light efficiently. When observing the sample 2, it is preferable to stop the emission of the laser light or to use an optical filter that does not transmit light in the wavelength band of the laser light. When observing the focus position of the laser light, it is preferable to use an optical filter that transmits light in the wavelength band of the laser light. A positioning device such as a stepping motor is preferably used to adjust the position of the laser light irradiation unit 6 or the liquid holding unit 3, and such a positioning device can be connected to a support unit of the laser light irradiation unit 6 or the liquid holding unit 3.

The spot size of the laser light on the sample 2 has an area of approximately 1×10^{-12 m}² or greater. The spot size can be changed as desired depending on the laser light focusing lens (not illustrated) and can be set to be greater than the size of the Taylor cone 23. A drive unit for driving the light source to emit pulsed laser light is preferably provided, and pulsed laser light having a pulse duration in the femtosecond to nanosecond range and a power of 10 J/m² or greater is used. The wavelength of the laser light may be in any of an ultraviolet range, a visible range, and an infrared range.

The end portion of the liquid holding unit 3 holding an accumulated liquid is preferably located in a space between the fine region 22 and the ion extract electrode 7. Specifically, The liquid holding unit 3, the fine region 22, and the ion extract electrode 7 may be arranged such that fine particulate matter 27 that desorbs from the fine region 22 as a result of being irradiated with the laser light can collide with the charged liquid droplets 29 and charged liquid droplets 29 can fly toward the ion extract electrode 7 from the liquid holding unit 3. The primary positions that allow the above functions to occur may be in a linear relationship or in a nonlinear relationship.

The liquid holding unit 3 may be needle-shaped like a capillary tube, conical, round column-shaped, pyramid-shaped, rectangular column-shaped, or elongated narrow plate-shaped, as long as the liquid holding unit 3 has an elongated shape.

The liquid holding unit 3 preferably includes a hollow flow channel in order to facilitate the supply of the liquid to the outer periphery of the end portion thereof.

The liquid holding unit 3 is preferably formed of a material having flexibility to a degree that allows, in particular, a flexural vibration so that the liquid holding unit 3 bends in a direction orthogonal to the longitudinal axis thereof.

Further, the liquid holding unit 3 preferably includes a flow channel having an opening at an end portion in order to supply the liquid to the outer periphery of the end portion thereof.

When the surface of the sample 2 is to be scanned with the laser light, that is, when a location of the fine region 22 of the surface of the sample 2 is to be changed, it is preferable to move the relevant constituent elements while maintaining the above-described relative positional relationship. Specifically, it is preferable to move the sample 2 by using a moving unit 10 while the positions of an irradiation optical system for the laser light and the liquid holding unit 3 are fixed. Alternatively, in a state where the sample 2 is fixed, the laser optical system and the liquid holding unit 3 may be moved to scan the surface of the sample 2 along the in-plane direction thereof while maintaining the relative positional relationship between the laser optical system and the liquid holding unit 3.

Upon the fine region 22 of the sample 2 being irradiated with the laser light, the fine particulate matter 27 is desorbed from the surface of the sample 2. At this point, since the fine region 22 has already undergone ionization in the mode A, components that have not been ionized in the mode A are to be desorbed. A Taylor cone 28 is formed at the end portion of the liquid holding unit 3, and the charged liquid droplets 29 are generated. The charged liquid droplets 29 at this point only contain the solvent, and the components contained in the solvent are to be ionized. Since the fine particulate matter 27 and the charged liquid droplets 29 are in close proximity to each other, the fine particulate matter 27 and the charged liquid droplets 29 collide with each other and exchange charges, and thus the fine particulate matter 27 becomes ionized. The ionized fine particulate matter 27 is guided to the ion extract electrode 7. The above-described processes will be referred to as the second operation mode (mode B).

An overview of switching between the mode A and the mode B is illustrated in FIG. 1B. In the mode A, the liquid holding unit 3 and the sample 2 are disposed to allow the liquid bridge 21 to be formed, and the sample 2 is not irradiated with the laser light during this period. Meanwhile, in the mode B, the disposition of the liquid holding unit 3 and the sample 2 is changed, and formation of the liquid bridge 21 is stopped. In addition, the surface of the sample 2 is irradiated with the laser light during this period. Here, a case where the position of a sample stage changes between the mode A and the mode B is illustrated in FIG. 1B. The sample stage is moved downward in the mode B from its position in the mode A, and thus the distance between the liquid holding unit 3 and the sample 2 is increased to stop the formation of the liquid bridge 21. In addition, by moving the sample 2 in the horizontal direction (i.e., in-plane direction of the surface of the sample 2), the sample 2 can be irradiated with the laser light in a state where reaction between the fine particulate matter 27 and the charged liquid droplets 29 is facilitated.

That is, the first exemplary embodiment is a method for analyzing a sample using laser light and a liquid holding unit that has an end portion; the end portion is configured to hold a liquid on an outer periphery thereof. Such a method includes bringing the liquid held on the outer periphery of the end portion into contact with a surface of the sample and then emitting ionized particles from the end portion, irradiating at least a region of the surface of the sample with the laser light, disposing the liquid on the end portion to a location separated from the surface of the sample, and ionizing the particles desorbed from the surface of the sample as a result of being irradiated with the laser light using the liquid at the end portion, guiding the ionized sample to a mass spectrometry unit, and carrying out mass spectrometry with the mass spectrometry unit.

As in the first exemplary embodiment, carrying out the ionization in the mode A and the ionization in the mode B separately from each other makes it possible to ionize a substance that easily dissolves in a mixture serving as a solvent that contains water, an organic solvent, and an acid or a base, and to ionize a substance that does not easily dissolve in the mixture at different points along a time axis. That is, components to be ionized can be separated, which has been difficult to do in existing techniques, and thus the number of components contained in obtained mass spectra can be reduced, which in turn facilitates interpretation of an attribution analysis result.

The ion extract electrode 7 includes a conductive member (not shown) and is connected to the voltage application unit 8. In operation, a predetermined voltage is applied to the ion extract electrode 7 by the voltage application unit 8. The ion extract electrode 7 is a structural member, for example, cylindrical in shape, which serves for forming a flow path through which ions contained in the liquid droplets that are separated from the Taylor cone are taken into the mass spectrometry unit. A pump (not illustrated) is connected to the ion extract electrode 7 serving as an ion take-in port, and the ions are attracted to the ion extract electrode 7 along with an outside environment, that is, a surrounding gas. The ions pass through the ion extract electrode 7 in a liquid state or in a gaseous state. Then, the ions fly in a gaseous state in a mass spectrometry device 9. The mass spectrometry device 9 is a time of flight (TOF) mass spectrometer that utilizes a TOF method. The ions fly through a vacuum flight space within the mass spectrometry device 9 and have their masses analyzed.

An image generation system according to the first exemplary embodiment includes a mass spectrometer and an image information generation device.

The mass spectrometer includes an ionization unit and a mass spectrometry unit.

The ionization unit corresponds to the ionization device that includes the support 1, the liquid holding unit 3, the laser light irradiation unit 6, the ion extract electrode 7, the liquid supply unit 4, and the voltage application units 5 and 8. The mass spectrometer corresponds to the mass spectrometry device 9.

As stated above, the liquid bridge 21 is formed in an extremely small region on the surface of the sample 2. In order to analyze a larger area of the surface of the sample 2, the moving unit 10 for moving the sample 2 in the in-plane direction thereof is provided. The moving unit 10 is connected to an analysis position specification unit 11, and the analysis position specification unit 11 is connected to the mass spectrometry device 9. The analysis position specification unit 11 specifies a region to be analyzed by the mass spectrometry device 9 as positional information and, in the mode A, moves the support 1 so that a solute present at the specified position is contained in the liquid bridge 21 and then in the Taylor cone 23. The result of mass spectrometry is obtained in the form of mass information such as mass spectral data by the mass spectrometry unit.

The analysis position specification unit 11 corresponds to the aforementioned image information generation device. The image information generation device includes an image generation unit that generates image information to be used to display an image on the basis of the result of mass spectrometry performed on the target substance at the specified position. The image information may be for a two-dimensional image or a three-dimensional image. The image information outputted from an output unit (not illustrated) of the analysis position specification unit 11 is sent to an image display unit 12 such as a flat panel display connected to the analysis position specification unit 11. The image information is inputted to the image display unit 12 and displayed in the form of an image. In this manner, carrying out mass spectrometry at multiple positions while changing the specified position along the surface of the sample 2 on the basis of the result of mass spectrometry performed on the specified position makes it possible to display the results of mass spectrometry performed on the sample 2 in the form of an image. In other words, the component distribution of the substances contained in the sample 2 can be displayed in the form of an image on the basis of the analyzed mass information and the positional information of the sample 2. A predetermined component in the biological tissue section is mapped in the image (multilayered display). In addition to the position of the component, the amount of the component is also displayed, and differences in the amount are indicated by varying colors or brightness. Further, it is also possible to display a superimposed image of a microscopic image of the sample 2 obtained in advance and an image indicating the obtained mass of the sample 2.

The vibration unit 13 is connected to the support 1 and is used to further increase the number of ions generated when the substance dissolving in the liquid bridge 21 is ionized in the mode A.

The ionization device according to the first exemplary embodiment uses a biological tissue section as a sample, a mixture containing water, an organic solvent, and an acid or a base as a solvent, at least any one of a lipid, a saccharide, and a high molecule having a mean molecular weight of 20 or more but less than a hundred million as a solute that easily dissolves in the solvent, and a molecule having a mean molecular weight of 20 or more but less than a hundred million as a solute that does not easily dissolve in the solvent. However, an ionization device according to an exemplary embodiment of the present invention can be applied to other combinations of a sample, a solvent, and solutes. For example, a ratio of water, an organic solvent, and an acid or a base in a solvent can be varied. One of the components in a given ratio may, for example, be 0, that is, one of the components may not be contained. Varying the ratio allows solubility, in the mixture, of a water-soluble molecule and a fat-soluble molecule contained in the sample to be varied, and thus ionization of a desired molecule can be prioritized.

In the first exemplary embodiment, although a mixture containing water, an organic solvent, and an acid or a base is used as a solvent, organic molecules that interact with laser light can be added to the solvent, and thus desorption and the ionization efficiency of the substance in the mode B can be enhanced. For example, providing a molecule such as a-cyano-4-hydroxycinnamic acid, 2,5-dihydroxybenzoic acid, sinapinic acid 3,5-dimethoxy-4-hydroxycinnamic acid, and 1,1,4,4-tetraphenyl-1,3-butadiene makes it possible to ionize the substance efficiently.

In the ionization device according to the first exemplary embodiment, the voltage application unit 5 applies a voltage to the solvent, and in this case the liquid holding unit 3 is preferably an insulator. Alternatively, an ionization device according to an exemplary embodiment of the present invention may be configured such that the voltage application unit 5 applies a voltage to the liquid holding unit 3 and, as a result, the voltage is applied to the solvent. In this case, the liquid holding unit 3 is preferably formed of a conductor, and the solvent is disposed so as to be in contact with the conductor.

In the ionization device according to the first exemplary embodiment, the liquid holding unit 3 has a flow channel formed therein, and the solvent flows in the flow channel. Alternatively, an ionization device according to an exemplary embodiment of the present invention may be configured such that the liquid supply unit 4 supplies liquid droplets to the liquid holding unit 3 and the liquid droplets flow along the liquid holding unit 3 to the end portion thereof so as to form the liquid bridge 21.

In the ionization device according to the first exemplary embodiment, the liquid holding unit 3 has a flow channel formed therein. Alternatively, an ionization device according to an exemplary embodiment of the present invention may include a plurality of flow channels, and distinct solvents may flow in the respective flow channels. In this case, a unit configured to apply distinct voltages to the respective solvents may be provided.

In the ionization device according to the first exemplary embodiment, the ion extract electrode 7 is connected to the voltage application unit 8 that is configured to apply a voltage to the ion extract electrode 7. In this case, the ion extract electrode 7 preferably includes a conductive member, and this conductive member is preferably connected to the voltage application unit 8.

Alternatively, an ionization device according to an exemplary embodiment of the present invention may be configured such that the ion extract electrode 7 is formed of an insulator and a conductive member is disposed on the ion extract electrode 7 at an end that is close to the liquid holding unit 3. Then, the voltage application unit 8 may be connected to the conductive member so as to apply a high electric field to the Taylor cone 23.

The ionization device according to the first exemplary embodiment may be used as an ion generation unit not only of a TOF mass spectrometer but also of a quadrupole mass spectrometer, a magnetic field deflection mass spectrometer, ion trap mass spectrometer, and ion cyclotron mass spectrometer.

In the ionization device according to the first exemplary embodiment, the liquid bridge and the Taylor cone are formed in an atmospheric pressure environment and the substance is ionized. Here, the atmospheric pressure covers a range of 0.1 to 10 times the standard atmospheric pressure of 101325 Pa. Alternatively, the environment may be in an atmosphere that is the same as a typical room environment, or in an inert gas atmosphere such as a nitrogen atmosphere or an argon atmosphere.

The ionization device according to the first exemplary embodiment is preferably configured such that the solvent continuously flows in the flow channel formed in the liquid holding unit 3 at a constant flow rate. Alternatively, the flow rate (flow speed) of the solvent may be controlled. That is, an increase or a decrease in the flow rate may be set to a desired value, and the flow rate may be increased when the amount of a substance to be dissolved is large or may be decreased when the amount of a substance to be dissolved is small. In this manner, the flow rate can be set in accordance with the amount of the substance to dissolve. Accordingly, a variation in the concentration of the substances dissolving in the liquid bridge 21 can be suppressed, and the substances in the sample 2 can be ionized efficiently.

Varying the flow rate also makes it possible to vary the size of the liquid bridge 21. The size of the liquid bridge 21 corresponds to the size of an ionization region and thus correlates with spatial resolution of a mass image. A small liquid bridge 21 leads to improved spatial resolution but increases the number of regions to be measured, and thus a total measurement time increases. That is, varying the flow rate makes it possible to vary the total measurement time. For example, after a mass image is obtained at low spatial resolution, an area in the mass image is specified. Then, a detailed mass image of the specified area is obtained at higher spatial resolution, and thus the total measurement time can be reduced.

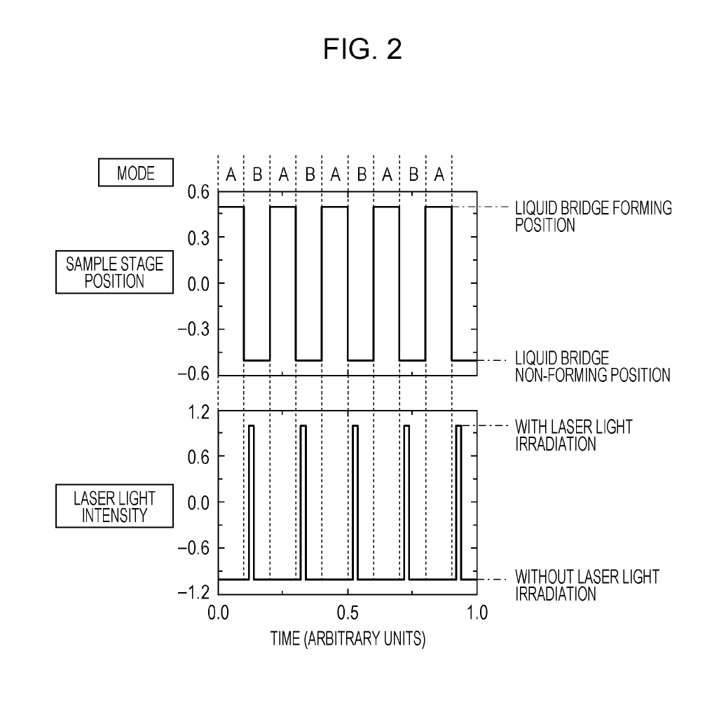

In the ionization device according to the first exemplary embodiment, the fine region 22 of the sample 2 is irradiated with the laser light continuously in the mode B. Alternatively, as illustrated in FIG. 2, the fine region 22 may be irradiated with the laser light intermittently during a given period of time. That is, the fine region 22 may be irradiated with the laser light for a given period of time, and then the irradiation may be stopped for another given period of time. Thus, a period in which the laser light interacts with a substance that is easily decomposed by the laser light can be reduced, and thus decomposition of the substance can be reduced. In addition, the above configuration can suppress a situation where the fine region 22 of the sample 2 is locally heated by the laser light, and thus degradation of the substance to be caused by the heat can be suppressed.

In the ionization device according to the first exemplary embodiment, a voltage is steadily applied to the ion extract electrode 7. Alternatively, a timing of the laser light irradiation and a timing of applying a voltage to the ion extract electrode 7 may be adjusted as desired. For example, a voltage may be applied to the ion extract electrode 7 for a given period of time immediately after the start of laser light irradiation. Then, unnecessary ions generated during a period in which the laser light is not radiated are not detected in the mode B, and thus ions generated immediately after the laser light is radiated can be collected efficiently. That is, ions of solvent components contained in the charged liquid droplets 29 are prevented from being detected while the charged liquid droplets 29 generated from the Taylor cone 28 have not interacted with the desorbed fine particulate matter 27. Thus, unnecessary ions can be prevented from being taken into the mass spectrometer, and a noise component in an obtained analysis result can be suppressed.

Two settings are configured for application of a voltage to the ion extract electrode 7 and the liquid holding unit 3, namely with or without voltage application, in the first exemplary embodiment. Alternatively, the voltage may have two set levels in which one allows an electrospray to be generated and the other does not. That is, the settings for application of a voltage to the ion extract electrode 7 and the liquid holding unit 3 can include a voltage that generates an electrospray and a voltage that does not generate an electrospray, and then an appropriate voltage may be applied.

In the ionization device according to the first exemplary embodiment, the position of the liquid holding unit 3 is fixed, and the position of the sample 2 is varied. Alternatively, both or either of the liquid holding unit 3 and the sample 2 may be moved as long as a relative distance between the liquid holding unit 3 and the sample 2 changes.

### Second Exemplary Embodiment

An ionization device according to a second exemplary embodiment of the present invention has a configuration in which an end portion of the liquid holding unit 3 is caused to vibrate. Points aside from the above are the same as those of the first exemplary embodiment.

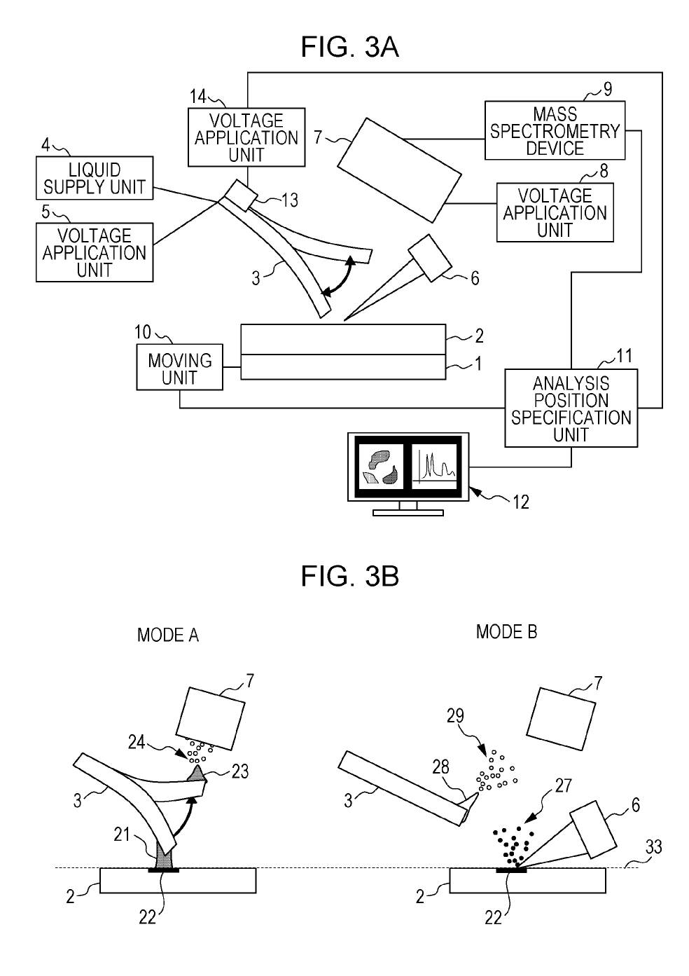

FIGS. 3A and 3B are schematic diagrams each illustrating an image generation system that includes the ionization device according to the second exemplary embodiment of the present invention. FIG. 3A illustrates the entire image generation system, and FIG. 3B illustrates two ionization modes under which the ionization device may operate the end portion of the liquid holding unit 3.

In the ionization device according to the second exemplary embodiment, the vibration unit 13 is provided on the liquid holding unit 3 instead of in the support 1. The vibration unit 13 is connected to a voltage application unit 14. The voltage application unit 14 is then connected to the analysis position specification unit 11. The vibration unit 13 causes the liquid holding unit 3 to vibrate in directions indicated by the double arrow in FIG. 3A.

The vibration unit 13 is formed by a piezoelectric element or a motor element and causes the liquid holding unit 3 to vibrate in a reciprocating manner. The amplitude of the vibration of the liquid holding unit 3 is approximately a few tens of nanometers to a few millimeters, and the frequency is approximately 10 Hz or more and up to 1 MHz.

The liquid holding unit 3 vibrates continuously, and if the liquid holding unit 3 makes contact with the sample 2 while vibrating, the liquid bridge 21 is formed between the liquid holding unit 3 and the sample 2. If the liquid holding unit 3 is separated beyond a certain distance from the sample 2 while vibrating, the liquid bridge 21 is not formed, but the Taylor cone 23 is generated and the liquid droplets 24 are sprayed. As described above, substances that are contained within the fine region 22 of the sample 2 and that easily dissolve in the solvent are ionized at the end portion of the liquid holding unit 3. These processes will be referred to as the mode A ionization.

After the ionization in the mode A, vibration of the liquid holding unit 3 is stopped to stop the formation of the liquid bridge 21.

The laser light irradiation unit 6 that emits the laser light includes a light source that is arranged such that the laser light irradiates the fine region 22 of the sample 2 where the liquid bridge 21 had just been formed. The laser light irradiation unit 6 is disposed at a side of the sample 2, that is, at a side of the support 1 where the sample 2 is to be placed.

Similar to the first exemplary embodiment, the fine region 22 of the sample 2 is irradiated with the laser light from the laser light irradiation unit 6, and substances contained in the fine region 22 of the sample 2 are ionized. The above processes will be referred to as the mode B ionization.

An overview of switching between the mode A and the mode B is illustrated in FIG. 3B. In the mode A, the liquid holding unit 3 and the sample 2 are disposed to allow the liquid bridge 21 to be formed, and the liquid holding unit 3 vibrates. The sample 2 is not irradiated with the laser light during this period. Meanwhile, in the mode B, the liquid holding unit 3 stops vibrating, and the formation of the liquid bridge 21 is stopped. The liquid holding unit 3 is moved in the horizontal direction to a location separated from the ion extract electrode 7. In addition, the surface of the sample 2 is irradiated with the laser light during this period.

In the second exemplary embodiment, a height 33 of the surface of the sample 2 is not changed between the mode A and the mode B, and switching between the mode A and the mode B illustrated in FIG. 3B are achieved by changing the position of the liquid holding unit 3 and the position of the extract electrode 7.

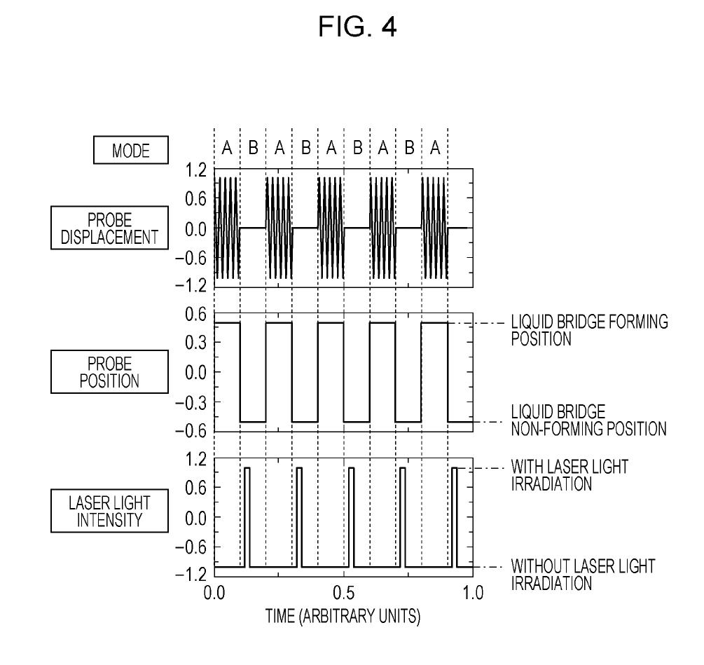

FIG. 4 is a schematic diagram illustrating operation timings of constituent elements in the ionization device according to the second exemplary embodiment. In the mode A, the liquid holding unit 3 vibrates, and the liquid bridge 21 is formed. In the mode B, the liquid holding unit 3 stops vibrating, and the position of the liquid holding unit 3 is changed. Thus, the liquid bridge 21 is eliminated, and the sample 2 is irradiated with the laser light. The timings of the above processes are preferably synchronized using an electric circuit for synchronization.

In the mode B, application of a voltage to the vibration unit 13 connected to the liquid holding unit 3 may be stopped to allow the liquid holding unit 3 to spontaneously stop vibrating. Alternatively, a voltage signal of an opposite phase to a voltage signal that has been inputted to the vibration unit 13 may be inputted to the vibration unit 13 for a short period of time to force the liquid holding unit 3 to stop vibrating.

In the mode B, the liquid holding unit 3 does not need to stop vibrating. Yet, the liquid bridge 21 may be prevented from forming by changing the position of the liquid holding unit 3 or by reducing the amplitude of the vibration of the liquid holding unit 3.

In the ionization device according to the second exemplary embodiment, the liquid holding unit 3 is moved in the horizontal direction to allow the fine particulate matter 27 to react with the charged liquid droplets 29 in the mode B. Alternatively, such a reaction may be carried out without moving the liquid holding unit 3 in the horizontal direction. For example, in the mode A, while the liquid holding unit 3 is in close proximity to the ion extract electrode 7 but the liquid bridge 21 is not formed, the fine region 22 where the liquid bridge 21 was present may be irradiated with the laser light, and then the desorbed fine particulate matter 27 may be allowed to react with the charged liquid droplets 29 to be ionized. In this case, a state where components dissolving in the liquid bridge 21 are ionized is referred to as the mode A, and a state where the laser light is radiated and the ionization is carried out is referred to as the mode B. An ionization device configured as described above does not require the time to change the relative positional relationship between the liquid holding unit 3 and the sample 2 between the mode A and the mode B, and thus ionization can be carried out in a very short period of time.

Meanwhile, moving the liquid holding unit 3 in the horizontal direction makes it possible to prevent the fine particulate matter 27 from adhering to the liquid holding unit 3 and the amount of the fine particulate matter 27 to react with the charged liquid droplets 29 from being reduced. Thus, this configuration is preferable when analyzing a component in a small amount.

As in the second exemplary embodiment, carrying out the ionization in the mode A and the ionization in the mode B separately from each other makes it possible to ionize a substance that easily dissolves in a mixture serving as a solvent that contains water, an organic solvent, and an acid or a base and a substance that does not easily dissolve in the mixture at different points along a time axis. That is, components to be ionized can be temporally separated, which has been difficult in an existing technique, and thus the number of components contained in obtained mass spectra can be reduced, which in turn facilitates interpretation of an attribution analysis result.

Furthermore, in the second exemplary embodiment, a period in which the liquid holding unit 3 is in contact with the sample 2 is reduced since the liquid holding unit 3 vibrates, and thus damage to the sample 2 to be caused by the liquid holding unit 3 in association with the relative movement of the liquid holding unit 3 and the sample 2 (i.e., relative movement in a scanning direction along the in-plane direction of the sample 2) can be suppressed. Further, reducing a period in which the liquid bridge 21 is formed leads to the reduction of the size of the liquid bridge 21, and thus a space where ionization takes place can be reduced in size.

In the ionization device according to the second exemplary embodiment, the vibration unit 13 causes the liquid holding unit 3 to vibrate. Alternatively, spontaneous resonance of the liquid holding unit 3 may be utilized without providing a vibration unit. This is considered to be possible if, for example, the size and the material of the liquid holding unit 3, the size of the flow channel formed in the liquid holding unit 3, the voltage applied thereto, and the flow rate of the solvent are set as follows.
Size of liquid holding unit: 10 μm to 100 mm in length
Material: glass, stainless steel, silicon, PMMA
Size of flow channel: 1 μm² to 1 mm² in cross section
Applied voltage: 0 V to ±10 kV
Flow rate of solvent: 1 nL to 1000 μL per minute

In the ionization device according to the second exemplary embodiment, the vibration unit 13 vibrates intermittently. Alternatively, in an ionization device according to an exemplary embodiment of the present invention, the vibration unit 13 may vibrate continuously as long as mass spectrometry of an ionized substance can be carried out. Here, “vibrating intermittently” refers to a case in which states where the liquid holding unit 3 vibrates and is stopped are repeated alternately or a case in which the amplitude and/or the cycle of the vibration of the liquid holding unit 3 change repeatedly.

A vibration frequency to be set in the vibration unit 13 may be a resonance frequency or a non-resonance frequency.

In the ionization device according to the second exemplary embodiment, the end portion of the liquid holding unit 3 vibrates in a space between the sample 2 and the ion extract electrode 7. Alternatively, in an ionization device according to an exemplary embodiment of the present invention, the liquid holding unit 3 may rotate in addition to vibrating. If the liquid holding unit 3 is to rotate, a desired vibration in two axial directions that are orthogonal to each other may be given to the liquid holding unit 3. In this case, the liquid holding unit 3 vibrates in a combined wave pattern of two sine waves.

In the ionization device according to the second exemplary embodiment, the liquid supply unit 4 continuously supplies the solvent to a space between the liquid holding unit 3 and the sample 2. Alternatively, in an ionization device according to an exemplary embodiment of the present invention, the liquid supply unit 4 may supply the solvent to a space between the liquid holding unit 3 and the sample 2 while the liquid holding unit 3 is in close proximity to (or in contact with) the sample 2 and may stop supplying the solvent while the liquid holding unit 3 is spaced apart from the sample 2. That is, the supply of the solvent and the vibration of the liquid holding unit 3 may be synchronized.

The vibration of the liquid holding unit 3 in the ionization device according to the second exemplary embodiment can be detected with various methods. For example, a side face of the liquid holding unit 3 may be irradiated with laser light that is different from the laser light with which the fine region 22 of the sample 2 is irradiated, and displacement of reflected light from the liquid holding unit 3 may be detected. As another example, an electric element for detecting a vibration may be connected to the liquid holding unit 3, and distortion in the liquid holding unit 3 may be detected on the basis of a change in electric resistance of the element. As yet another example, a magnetic member may be connected to the liquid holding unit 3, and a change in an induced current that flows in a coil disposed close to the liquid holding unit 3 may be detected.

In the ionization device according to the second exemplary embodiment, as in the first exemplary embodiment, the fine region 22 of the sample 2 may be irradiated with the laser light intermittently for a given period of time in the mode B, and thus a similar effect to that of the first exemplary embodiment can be obtained.

If the liquid holding unit 3 vibrates, synchronization of the formation of the Taylor cone 28 and the irradiation with the laser light can be achieved by adjusting the frequency and the phase of the vibration of the liquid holding unit 3 and the frequency and the phase of a control signal for the laser light. It is preferable to synchronize a signal obtained by monitoring the vibration of the liquid holding unit 3 with a signal for controlling an irradiation timing of the laser light using a synchronization circuit.

In the ionization device according to the second exemplary embodiment, a voltage is steadily applied to the ion extract electrode 7. Alternatively, the vibration timing of the liquid holding unit 3 and the timing of applying a voltage to the ion extract electrode 7 may be synchronized. Then, unnecessary ions generated during a period in which the liquid bridge 21 is formed in the mode A are not detected, and thus noise in the obtained measurement data can be reduced. Here, the synchronization of the vibration timing of the liquid holding unit 3 with the timing of the laser light irradiation described above may be carried out additionally. Two settings are configured for application of a voltage to the ion extract electrode 7 and the liquid holding unit 3, namely with or without voltage application, in the second exemplary embodiment. Alternatively, the voltage may have two set levels in which one allows an electrospray to be generated and the other does not. That is, the settings for application of a voltage to the ion extract electrode 7 and the liquid holding unit 3 can include a voltage that generates an electrospray and a voltage that does not generate an electrospray, and then an appropriate voltage may be applied.

Synchronization of the formation of the liquid bridge 21, irradiation of the laser light, and the timing of applying a voltage to the ion extract electrode 7 can be achieved by adjusting the frequencies and the phases of the vibration of the liquid holding unit 3, the control signal for the laser light, and the control signal for voltage application. These signals are preferably synchronized using a synchronization circuit.

In the ionization device according to the second exemplary embodiment, the position of the liquid holding unit 3 is fixed, and the position of the sample 2 is varied. Alternatively, both or either of the liquid holding unit 3 and the sample 2 may be moved as long as a relative distance between the liquid holding unit 3 and the sample 2 changes.

### Third Exemplary Embodiment

In an ionization device according to a third exemplary embodiment of the present invention, the mode A and the mode B, which are carried out using the single liquid holding unit 3 in the first and second exemplary embodiments, are carried out using two liquid holding units, namely a first liquid holding unit 3a and a second liquid holding unit 3b . That is, of the two liquid holding units, the first liquid holding unit 3a carries out the mode A and the second liquid holding unit 3b carries out the mode B. This configuration makes it unnecessary to change the relative positional relationship between the liquid holding unit 3 and the sample 2 in order to switch between the mode A and the mode B as in the first and second exemplary embodiments, and thus the time it takes for ionization can be reduced.

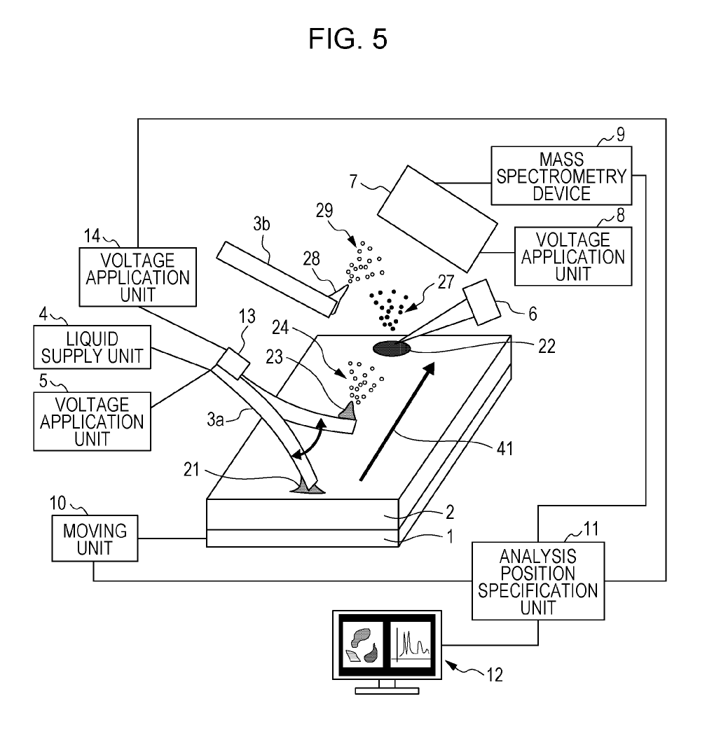

FIG. 5 is a schematic diagram illustrating an image generation system that includes the ionization device according to the third exemplary embodiment of the present invention. In the third exemplary embodiment, the two modes A and B described in the second exemplary embodiment are carried out by the two liquid holding units, respectively. The first liquid holding unit 3a carries out the ionization in the mode A, and the second liquid holding unit 3b carries out the ionization in the mode B. As the sample 2 is moved, a region that has been ionized in the mode A moves to a region to be ionized in the mode B, and this region is then ionized. At this time, the sample 2 is moved in a direction 41. The sample 2 is irradiated with the laser light under the condition where the distance between the first liquid holding unit 3a and the second liquid holding unit 3b is equal to the distance in which the sample 2 has been moved. Then, the ionization in the mode B occurs, and the same region can be ionized in the mode A and the mode B. A liquid supply unit and a voltage application unit are also connected to the second liquid holding unit 3b (not shown in FIG. 5). It is preferably that different liquid supply units and voltage application units are connected to each liquid holding unit, respectively. It is also possible that common liquid supply unit and voltage application unit are connected to both liquid holding units.

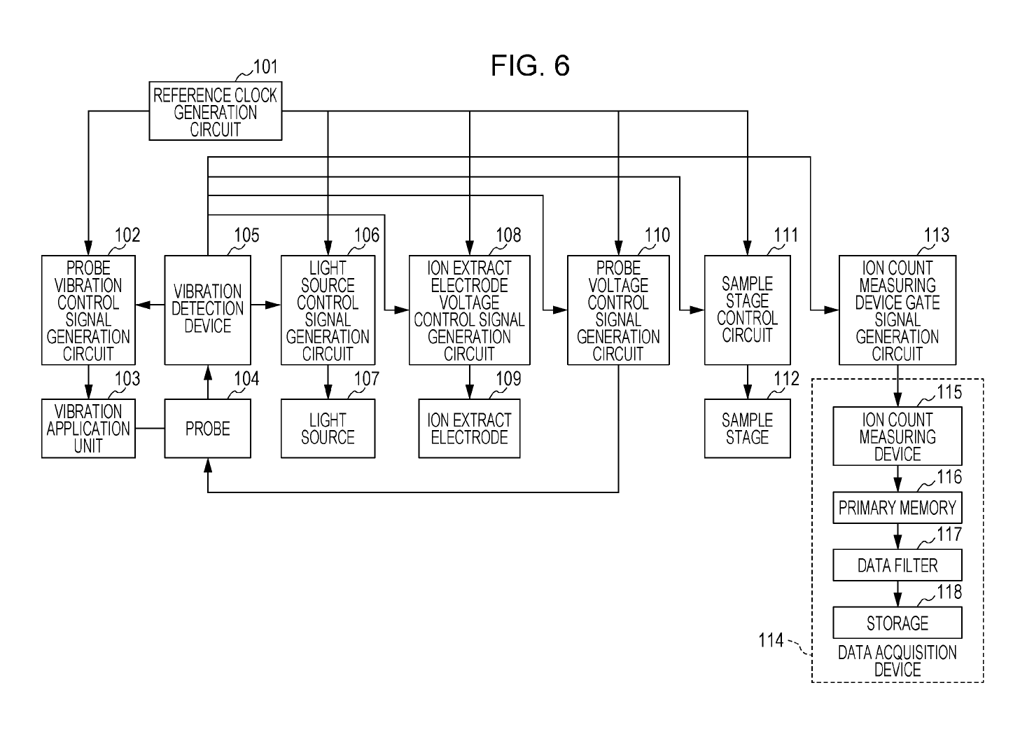

In the ionization device according to the third exemplary embodiment, it is necessary to precisely adjust a timing at which a probe vibrates, a timing of laser light irradiation, application of a voltage to an extract electrode, a voltage applied to the probe, a timing at which a sample stage is moved, and acquisition and storage of data. An exemplary embodiment of a synchronization circuit for achieving the above is illustrated in FIG. 6.

The synchronization circuit of the exemplary embodiment includes a reference clock generation circuit 101, a probe vibration control signal generation circuit 102, a vibration application unit 103, a probe 104, a vibration detection device 105, a light source control signal generation circuit 106, a light source 107, an ion extract electrode voltage control signal generation circuit 108, an ion extract electrode 109, a probe voltage control signal generation circuit 110, a sample stage control circuit 111, a sample stage 112, an ion count measuring device gate signal generation circuit 113, and a data acquisition device 114. The data acquisition device 114 includes an ion count measuring device 115, a primary memory 116, a data filter 117, and a storage 118.

Here, a case where a field programmable gate array (FPGA) or an application specific integrated circuit (ASIC) is used will be described as an example. The use of the FPGA or the ASIC makes it possible to implement a plurality of control circuits (i.e., reference clock generation circuit 101, probe vibration control signal generation circuit 102, light source control signal generation circuit 106, ion extract electrode voltage control signal generation circuit 108, probe voltage control signal generation circuit 110, sample stage control circuit 111) on an integrated circuit and to precisely adjust their control timings at high speed.

The probe vibration control signal generation circuit 102, the light source control signal generation circuit 106, the ion extract electrode voltage control signal generation circuit 108, the probe voltage control signal generation circuit 110, the sample stage control circuit 111, and the ion count measuring device gate signal generation circuit 113 generate respective voltage signals and output the generated voltage signals to the vibration application unit 103, the light source 107, the ion extract electrode 109, the probe 104, the sample stage 112, and the ion count measuring device 115, respectively. Each of these voltage signals may be any one of a triangular wave, a square wave, a sine wave, and a cosine wave.

A feedback circuit is formed in the probe vibration control signal generation circuit 102 in order to bring a phase difference between a voltage signal obtained by detecting an actual vibration of the probe 104 and a voltage signal generated on the basis of a reference clock to zero, and driving this feedback circuit allows the probe 104 to vibrate at a constant frequency. The vibration detection device 105 is used to detect the actual vibration of the probe 104, and an output signal from the vibration detection device 105 is inputted to the feedback circuit in the probe vibration control signal generation circuit 102. Such a drive mechanism is known as a phase locked loop (PLL). Providing a delay compensation circuit within a circuit for the PLL makes it possible to generate a voltage signal having a desired delay time relative to a reference signal.

The output signal from the vibration detection device 105 is also inputted to the light source control signal generation circuit 106, the ion extract electrode voltage control signal generation circuit 108, the probe voltage control signal generation circuit 110, the sample stage control circuit 111, and the ion count measuring device gate signal generation circuit 113. Certain times such as a timing at which the probe 104 forms a liquid bridge, a timing at which ionization occurs at the end portion of the probe 104, and a timing between the liquid bridge formation and the ionization are extracted on the basis of the inputted voltage signals, and driving of the devices that are connected to the respective circuits at the aforementioned timings are controlled. For example, a signal of displacement of the probe 104 in FIG. 4 serves as an output signal from the vibration detection device 105, and when this signal is inputted to the light source control signal generation circuit 106, the ion extract electrode voltage control signal generation circuit 108, the probe voltage control signal generation circuit 110, and the sample stage control circuit 111, a specific threshold voltage may be set. Then, a period in which a voltage falls below the threshold voltage can be set as a timing of forming a liquid bridge, or a period in which a voltage exceeds the threshold voltage can be set as a timing at which ionization occurs. Then, a timing at which a voltage is applied to the probe 104, a timing at which the light source 107 emits light, a timing at which a voltage is applied to the ion extract electrode 109, and a timing at which the sample stage 112 is moved are controlled so as to synchronize with the timings determined as described above. Further, using a signal from the reference clock generation circuit 101 makes it possible to quantitatively measure and to control a timing at which a voltage is applied to the probe 104, a timing at which the light source 107 emits light, a timing at which a voltage is applied to the ion extract electrode 109, and a timing at which the sample stage 112 is moved.

An output signal generated by the ion count measuring device gate signal generation circuit 113 is inputted to the ion count measuring device 115 as a gate voltage signal. Generally, the ion count measuring device 115 intermittently receives a trigger signal from the mass spectrometer, and after receiving the trigger signal, the ion count measuring device 115 measures the number of ions that have reached the detector in the mass spectrometer. A trigger signal differs depending on the configuration of an ion separation unit in the mass spectrometer. In the exemplary embodiment, a quadrupole mass spectrometer, a TOF mass spectrometer, a magnetic field deflection mass spectrometer, or an ion trap mass spectrometer may be used as the mass spectrometer, and a specific timing may be used as a trigger signal for each instance of mass spectrometry.

For example, a signal indicating a timing of starting application of a high frequency voltage to a quadrupole electrode may be used as a trigger signal in the quadrupole mass spectrometer. In the TOF mass spectrometer, a signal indicating a timing of application of a pulse voltage for accelerating an ion in a device that measures the time of flight of the ion may be used as a trigger signal. In the magnetic field deflection mass spectrometer, a signal indicating a timing at which a magnetic field starts to be applied to a sector electrode may be used as a trigger signal. In the ion trap mass spectrometer, a signal indicating a timing at which an ion is introduced to an ion trap may be used as a trigger signal. Typically, the frequency of the pulse voltage in the TOF mass spectrometer is approximately a few kHz to a few tens of kHz, and the frequency of trapping ions in the ion trap mass spectrometer is approximately a few tens of Hz to a few kHz. Thus, the frequency is often higher than the vibration frequency of the probe 104.

In the exemplary embodiment, a gate voltage signal is outputted in synchronization with a timing at which ionization occurs at the end portion of the probe 104. The ion count measuring device 115 is configured to operate in accordance with a period in which the gate signal is outputted. Here, the gate signal is any one of a positive voltage, a negative voltage, and a zero voltage and differs depending on the ion count measuring device 115. The ion count measuring device 115 can be configured to operate only while ions are generated at the probe 104, and thus a noise signal is not measured while the liquid bridge is formed and during period from when the liquid bridge is formed until the ionization occurs. Therefore, a noise signal to be contained in a signal of measured data can be reduced.

Subsequently, a method for recording a voltage signal from the ion count measuring device 115 in the form of digital data will be described. A signal from the ion count measuring device 115 undergoes analog-to-digital conversion and is then temporarily stored in the primary memory 116. Measurement data that corresponds to the type of ions to be measured is selected and stored in the storage 118 such as a hard disk drive (HDD) and a solid state drive (SSD). This process of selecting the data is carried out through a program in the data filter 117, and the data is overwritten by new data in the memory. Since the data is stored in the storage 118 after being selected, the total amount of data can be reduced, and the selected data can be applied if the ion to be measured is determined in advance. Meanwhile, if an unknown ion is to be detected, the entire data obtained by the ion count measuring device 115 can be stored in the storage 118.

If a large area on a measurement target is to be measured, the sample stage 112 needs to be moved. The sample stage control circuit 111 generates a signal for controlling the position of the sample stage 112 on the basis of a reference clock and outputs the generated signal to the sample stage 112. At this point, by measuring a timing at which ionization occurs at the end portion of the probe 104 and the number of instances of ionization within a given period of time on the basis of the signal from the vibration detection device 105, the number of instances of ionization per position on a sample can be kept constant. Acquisition and storage of the data can be carried out successively while moving the sample stage 112. Thus, pieces of two-dimensional data on the measurement target can be stored successively.

Thus far, a case where the signal generation circuits generate respective output signals relative to a threshold has been described, but the exemplary embodiments are not limited thereto. A common signal generation circuit may be provided separately, and the common signal generation circuit may extract specific times on the basis of a signal from the vibration detection device 105. Then, the common signal generation circuit may input a voltage signal corresponding to the extracted times to the light source control signal generation circuit 106, the extract electrode voltage control signal generation circuit 108, the probe voltage control signal generation circuit 110, the sample stage control circuit 111, and the ion count measuring device gate signal generation circuit 113.

In the exemplary embodiment, a synchronization method in a case where the probe 104 vibrates has been described. Alternatively, if the probe 104 is paused, the probe vibration control signal generation circuit 102, the vibration application device 103, and the vibration detection device 105 that relate to the vibration of the probe 104 may be stopped, and various control signals may be generated using signals from the reference clock generation circuit 101 in the respective control circuits.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-197206, filed Sep. 7, 2012, which is hereby incorporated by reference herein in its entirety.

What is claimed is:

1. An ionization device, comprising:
a laser light irradiation unit configured to irradiate at least a region of a surface of a sample with laser light to desorb a particle from the sample;
at least one liquid holding unit having an end portion, the at least one liquid holding unit being configured to hold a liquid on an outer periphery of the end portion;
an extract electrode configured to extract an ionized ion; and
a voltage application unit configured to apply a voltage between the liquid and the extract electrode to cause the ion to generate from the liquid held on the outer periphery of the end portion,
wherein the ionization device is configured to operate in at least two operation modes, the two operation modes including
a first operation mode in which the liquid on the end portion is brought into contact with the surface of the sample and then an ionized particle is generated from the end portion, and
a second operation mode in which the liquid on the end portion is disposed at a location separated from the surface of the sample and the particle desorbed from the surface of the sample as a result of being irradiated with the laser light is ionized using the liquid on the end portion.

2. The ionization device according to claim 1,
wherein the first and second operation modes are carried out by the at least one liquid holding unit,
wherein the ionization device further includes a position changing unit configured to change a relative distance between the surface of the sample and the end, and
wherein the position changing unit is configured to change the relative distance at least between a first distance where the liquid on the end portion makes contact with the region to form a liquid bridge and a second distance where the liquid on the end portion is spaced apart from the region of the sample.

3. The ionization device according to claim 1, wherein the at least one liquid holding unit includes a first liquid holding unit configured to carry out the first operation mode and a second liquid holding unit configured to carry out the second operation mode.

4. The ionization device according to claim 1, further comprising:
a vibration unit configured to cyclically change the relative distance between the end portion of the holding unit and the sample.

5. The ionization device according to claim 2, wherein the second operation mode is carried out on the surface of the sample with which the liquid has made contact in the first operation mode after the relative distance is changed from the first distance to the second distance.

6. The ionization device according to claim 1, wherein the laser light irradiation unit includes a drive unit configured to drive the laser light irradiation unit to emit pulsed laser light.

7. The ionization device according to claim 1, further comprising:
a scanning unit configured to scan the surface of the sample while relatively moving the end portion of the holding unit and the laser light.

8. The ionization device according to claim 7, wherein the scanning unit is configured to scan while retaining a positional relationship between the end portion of the holding unit and the laser light.

9. The ionization device according to claim 1, wherein the liquid holding unit includes a flow channel having an opening at the end portion, the flow channel being formed inside the liquid holding unit for supplying the liquid to the outer periphery of the end portion.

10. The ionization device according to claim 1, wherein the liquid holding unit includes an electrode for applying a voltage to the liquid on the end portion.

11. The ionization device according to claim 1, further comprising:
a synchronization circuit configured to synchronize a timing of the laser light irradiation with a timing at which one of the sample and a probe vibrates.

12. The ionization device according to claim 1, further comprising:
a synchronization circuit configured to synchronize a timing of the laser light irradiation with a timing at which a voltage is applied between the liquid and the extract electrode.

13. The ionization device according to claim 1, further comprising:
a synchronization circuit configured to synchronize a timing of the laser light irradiation with an operation timing of an ion count measuring device connected to the ionization device.

14. The ionization device according to claim 1, further comprising:
a synchronization circuit configured to synchronize a timing of the laser light irradiation with a timing at which a voltage is applied to an ion extract electrode of the ionization device.

15. The ionization device according to claim 1, further comprising:
a synchronization circuit configured to synchronize a timing of the laser light irradiation with at least two of a timing at which one of the sample and a probe vibrates, a timing at which a voltage is applied to the electrode, an operation timing of an ion count measuring device connected to the ionization device, and a timing at which a voltage is applied between the liquid and the extract electrode.

16. A mass spectrometer, comprising:
the ionization device according to claim 1 serving as an ionization unit; and
a mass spectrometry unit configured to analyze a mass-to-charge ratio of the ion.

17. An image generation system, comprising:
the mass spectrometer according to claim 16; and
an image information generation device that includes
an image generation unit configured to generate image information to be used to display an image of a component distribution of a substance contained in the sample on the basis of mass information obtained through analysis by the mass spectrometer and positional information on the region of the surface of the sample, and
an output unit configured to output the image information to a display device.

18. A method for analyzing a sample using laser light and a liquid holding unit having an end portion thereof, the liquid holding unit being capable of holding a liquid on an outer periphery of the end portion, the method comprising:
bringing the liquid held on the outer periphery of the end portion into contact with a surface of a sample and then emitting an ionized particle from the sample;
irradiating at least a region of the surface of the sample with the laser light, disposing the liquid on the end portion to a location separated from the surface of the sample, and ionizing, using the liquid on the end portion, the particle desorbed from the surface of the sample as a result of being irradiated with the laser light;
guiding the ionized particle to a mass spectrometry unit; and
carrying out mass spectrometry with the mass spectrometry unit.
